(19) United States
(12) Patent Application Publication
(10) Pub. No.: US 2025/0171239 A1
(43) Pub. Date: May 29, 2025

(54) TRANSPORT SYSTEM, TRANSPORT DEVICE AND RUNNING RAIL

(71) Applicant: Beckhoff Automation GmbH, Verl (DE)

(72) Inventors: Joerg Neufeld, Paderborn (DE); Ray Boehnke, Verl (DE)

(21) Appl. No.: 19/042,706

(22) Filed: Jan. 31, 2025

Related U.S. Application Data
(63) Continuation of application No. PCT/EP2023/072042, filed on Aug. 9, 2023.

(30) Foreign Application Priority Data
Aug. 9, 2022 (DE) 10 2022 120 032.9

(51) Int. Cl. B65G 19/20; B65G 35/06; B65G 54/02

(52) U.S. Cl. CPC B65G 19/205; B65G 35/06; B65G 54/02

(57) ABSTRACT

A transport system and device and a running rail are provided. The transport system comprises a running rail having a running rail section and the movable transport device. A first running surface of the running rail section comprises a substantially rounded surface and includes a guide center. The guide center substantially forms a geometric circle center, the circular surface of which in each case approximately encloses the rounded surface of the first running surface. A first roller of the transport device rotatably abuts on the first running surface. The first roller is rotatably mounted on a movable element of the transport device. The first roller is configured to carry out a pivoting movement along the rounded surface of the first running surface. A rotational axis of the movable element and the guide center are arranged at substantially the same height.

### CROSS-REFERENCE TO RELATED APPLICATIONS

This patent application is a continuation of International Patent Application PCT/EP2023/072042, filed Aug. 9, 2023, entitled “Transport System, Transport Device and Running Rail,” which claims the priority of German patent application DE 10 2022 120 032.9, filed Aug. 9, 2022, entitled “Transportsystem, Transportvorrichtung und Laufschiene,” which are incorporated by reference herein, in the entirety and for all purposes.

### FIELD

The present invention relates to a transport system, a transport device for a transport system and a running rail for use with the transport device in the transport system.

### BACKGROUND

Transport devices having a plurality of rollers and having contact with a curved running rail of a transport system via the rollers have been disclosed, inter alia, in EP 3 476 773 A1. EP 3 476 773 A1 discloses a transport device which interacts with a running rail, wherein the transport device comprises three rollers, of which two rollers each rotatably abut on a first running surface of the running rail and a third roller rotatably abuts on a second running surface of the running rail. The first and second running surfaces are each arranged on opposite sides of the running rail.

In order to ensure that said rollers have contact with the running surfaces of the running rail—in particular in a curved running rail section or in a transition from a straight to a curved running rail section (and vice versa)—the third roller is translationally mounted on a movable clement of the transport device. The movable element is preloaded via a spring unit, wherein the spring unit causes a spring force which allows for a translatory movement of the third roller relative to the first and second roller, for example in a vertical direction towards or away from each other.

However, with such preloaded transport devices or transport systems that comprise a spring-loaded moving clement with a translatory guide or linear guide, the problem of an unwanted torque on this translatory guide occurs frequently, as a result of which a parallel and therefore stable alignment of the transport device to the running rail is no longer guaranteed during guidance along a curved section of the running rail. The transport device therefore begins to tilt. The effect could be avoided, for example, if the spring unit and the linear guide were arranged in the same plane in which the third roller itself is arranged.

There is a need to provide improved transport system and an improved transport device for a transport system with stable guidance.

SUMMARY

According to a first aspect, a transport system comprises at least one running rail having at least one running rail section and at least one movable transport device, which is guided along the at least one running rail section, wherein the running rail section comprises a first running surface, wherein the first running surface comprises a substantially rounded surface and includes a guide center, wherein the guide center essentially forms a geometric circle center, the circular surface of which approximately encloses the rounded surface of the first running surface, wherein the transport device comprises at least a first roller which rotatably abuts on the first running surface, wherein the first roller is rotatably mounted at least one movable element of a base body of the transport device in order to carry out a pivoting movement along the substantially rounded surface of the first running surface, and wherein a rotational axis of the movable element and the guide center are arranged substantially at the same height for the pivoting movement.

According to a second aspect, a transport device for a transport system is provided. The transport system comprises at least one running rail having at least one running rail section, wherein the transport device is guided along the at least one running rail section, wherein the running rail section comprises a first running surface, wherein the first running surface comprises an essentially rounded surface and comprises a guide center, wherein the guide center essentially forms a geometric circle center, the circular surface of which approximately encloses the rounded surface of the first running surface, wherein the transport device comprises at least a first roller which rotatably abuts on the first running surface, wherein the first roller is rotatably mounted on at least one movable element of a base body of the transport device in order to carry out a pivoting movement along the substantially rounded surface of the first running surface, and wherein a rotational axis of the movable element for the pivoting movement and the guide center are essentially arranged at the same height.

According to a third aspect, a running rail comprises at least one running rail section along which the transport device is guided. The running rail section further comprises a first running surface, wherein the first running surface comprises a substantially rounded surface and comprises a guide center, wherein the guide center essentially forms a geometric circle center, the circular surface of which approximately encloses the rounded surface of the first running surface, wherein the transport device comprises at least a first roller which rotatably abuts on the first running surface, wherein the first roller is rotatably mounted on at least one movable element of a base body of the transport device in order to carry out a pivoting movement along the substantially rounded surface of the first running surface, and wherein a rotational axis of the movable element for the pivoting movement and the guide center are arranged essentially at the same height.

EXAMPLES

A transport system is proposed which comprises at least one running rail having at least one running rail section and at least one movable transport device which is guided along the at least one running rail section. The running rail section comprises a first running surface. The first running surface comprises a substantially rounded surface and comprises a respective guide center. In each case, the guide center forms essentially a geometric center of a circle, the circular surface of which in each case approximately encloses the rounded surface of the first running surface. The transport device comprises at least one first roller which rotatably abuts on the first running surface, the first roller being rotatably mounted on at least one movable element of a base body of the transport device in order to carry out a pivoting movement along the essentially rounded surface of the first running surface, a rotational axis of the movable element for the pivoting movement and the guide center being arranged essentially at the same height.

The running rail comprises at least one curved running rail section. The transport device is guided along the at least one curved running rail section. The curved running rail section comprises the first running surface and a second running surface arranged on opposite sides of the curved running rail section. The first running surface and the second running surface each comprise the substantially rounded surface and each comprise the guide center. In each case, the guide center forms essentially a geometric center of a circle, the circular surface of which in each case approximately encloses the rounded surface of the first running surface or the rounded surface of the second running surface.

The transport device comprises a plurality of rollers for guidance. At least the first roller and a second roller each rotatably abut on the first running surface and at least a third roller lies rotatably against the second running surface. The first roller and the second roller and/or the third roller are rotatably mounted on at least one movable element of a base body of the transport device. The first roller and the second roller and/or the third roller, which are each rotatably mounted on the movable element, are each embodied to carry out a pivoting movement along the substantially rounded surface of the first running surface and/or to carry out a pivoting movement along the substantially rounded surface of the second running surface. A rotational axis of the movable element and the guide center are arranged essentially at the same height.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a perspective view of a transport device having a curved rail section.

FIG. 2 is a schematic depiction of an arrangement of rollers of the transport device.

FIG. 3 shows a sectional view of the transport device.

FIG. 4 is a detailed section from FIG. 3 with indicated roller pivoting movement when adjusting the roller preload.

FIG. 5 is an enlarged perspective view of the movable element on which a first roller and a second roller of the transport device are rotatably mounted.

FIG. 6 shows a transport system having the transport device in a perspective view.

FIG. 7 is an enlarged sectional view of the transport device having a straight running rail section.

FIG. 8 is a schematic depiction of a removal process of the transport device from the running rail.

### DETAILED DESCRIPTION

By way of approximation, an order of magnitude may, for example, be up to 1 mm difference in the height arrangement of the rotational axis of the movable element and the guide center, and for this may also be understood as lying approximately in a joint plane.

A substantially rounded surface may be understood to mean a rounded or round running rail profile or a rounded or round surface/surface. For example, in a two-dimensional depiction, the running roller profile may approximately comprise a segment of a circle.

A pivoting movement may be a rotary movement that is directed away from the base body of the transport device. In particular, it may be used to readjust the preload in a curved section of the running rail, i.e. a curved area, and to maintain roller contact on the running surfaces of the running rail.

The guide center may be an axis that runs through the running rail and is approximately at the same height or in a joint plane with the rotational axis of the movable element.

The proposed transport system or the proposed transport device for the transport system advantageously improve a positioning accuracy of a drive device of the transport device of the transport system with the aid of the preferably rotational mounting of the first and second roller via the movable element. The drive device is preferably embodied as a linear drive and may comprise motor modules with coils, which are embodied in particular as linear motor modules along the running rail. The thrust force of the transport device, which leads to a movement of the transport device along the running rail, may result from an operative connection between magnets, which are arranged at the transport device, and the coils of the motor modules. With the help of the proposed design, magnets and coils may overlap better in their position and thereby strengthen their operative connection for the movement of the transport device.

A further advantage of the proposed transport system or of the proposed transportation device, respectively, is that based on the preferably rotational mounting of the first roller on the movable element, the transport device may be placed on the running rail more easily (or may be removed from the running rail more easily) than conventional systems, which require the use of a so-called rail lock—i.e. a running rail section to be inserted into the running rail specifically for this purpose—to rerail or remove transport devices. For this purpose, the running rail must be at least partially misaligned. Both the rail lock and the steps to be carried out in this connection are completely eliminated with the proposed arrangement.

Furthermore, the proposed arrangement may be used to ensure that the change in the preload, contact pressure, contact pressure or roller force between a straight running rail section and a curved running rail section for the first roller of the transport device on the first running surface and the base body of the transport device is low. This also has an advantageous effect on the vibration behavior and control parameters of the transport device or of the transport system and improves the stability of the transport device on the running rail so that it may be guided more easily along the running rail.

The stability of the transport device on the running surfaces of the running rail of the transport system depends on a plurality of factors and is largely determined by the distance between the opposing rollers, the choice of roller and running rail profile and the preloading force of the transport device on the running surfaces of the running rail of the transport system. The position of the rotational axis of the movable element and the center of the guide approximately at the same height, i.e. in a joint plane on the transport device, has a particularly positive effect on the stability of the transport device, as this arrangement prevents the transport device from starting to tilt overall during the pivoting movement along the curved surface of the running surface in the curved running rail section. Despite the pivoting movement, the transport device remains stable on the running surfaces.

In a further embodiment, during the pivoting movement, the first roller defines a pivoting plane which is inclined relative to a travel plane which is oriented essentially in parallel with regard to a guide direction of the first roller. Advantageously, despite the pivoting movement of the movable element, which is preferably embodied as a hinge block, for adjusting the preload in a curved section of the running rail, an overall tilting of the transport device may be prevented, but contact of the first roller with the running surfaces may still be maintained. For this purpose, the position of the rotational axis of the movable element and the guide center is advantageously selected in accordance with the above description.

In a further embodiment, the movable element for rotational mounting is preloaded via at least one spring unit, which is adjacent to the movable element. The spring unit comprises a spring element. The spring element and the rotational axis are at a first distance from each other. The first roller and the rotational axis are each at a second distance from each other. The first distance may be larger than the second distance.

The said arrangement has the advantage that a spring force provided by the spring unit, utilizing the lever law for the said distances, leads to an increased roller force acting on the first and second roller for pressing against the first running surface (for example, the spring force may advantageously be increased by a factor with the aid of the proposed arrangement). Advantageously, this circumstance may be taken into account when selecting the spring element. It is therefore preferable to use a helical compression spring as the spring element of the spring unit, as it offers high fatigue strength, has compact dimensions and may generate a relatively high spring force. The contact force, pressure force, preload force or roller force is advantageously derived from the spring force, as mentioned above.

In a further embodiment, the spring unit also comprises a tensioning element, which is embodied in particular as a tensioning screw. The tensioning element is embodied to preload the spring clement, which is embodied in particular as a helical compression spring. Advantageously, the preload may be adjusted or changed using the spring unit without having to remove the transport device from the running rail. This saves time and costs.

In addition, a small spring element may be used to achieve the required preload force by utilizing the above-mentioned leverage effect, which advantageously allows a compact, space-saving design of the transport device and the transport system. The type of spring used for the spring element (helical compression spring) has a high fatigue strength and is therefore robust and ideal for use.

Automatic readjustment of the roller or running roller wear with the aid of the spring-loaded, rotational mounting also allows for an almost constant preload over the entire running time (thus extending the running time of the individual components, especially the rollers) as well as constant control and oscillation behavior of the transport device (without the need for readjustment).

In a further embodiment, the transport system comprises a drive device for the transport device. The drive device is preferably embodied as a linear drive and may comprise motor modules with coils, which are embodied in particular as linear motor modules along the running rail. The coils may be energized individually. The magnets are arranged on the at least one transport device.

The coils generate a magnetic field for an operative connection with the magnets, which are arranged on the at least one transport device. The at least one transport device is set in motion by the operative connection.

The advantage of the embodiment of the transport system is that no cables are required for the implementation. These would make the transport system confusing and lead to limited mobility of the transport device. In addition, the transport system does not require complicated installation and maintenance, as no gears, belts or chains are used for the transport system. With the aid of flexible movement profiles (e.g. control of only individual transport devices of the transport system, etc.), simple to highly complex sequences may also be implemented, thus optimizing the entire production process. In addition, the proposed transport system is manufactured in an easy-to-clean design and is therefore also advantageously suitable for hygienically sensitive areas of application.

In a further embodiment, the base body of the transport device is essentially U-shaped and comprises a base with a first leg and a second leg. The base body comprises a recess at least partially on an outer side of the base and an outer side of the first leg, in which the at least one movable element is arranged. The spring element is arranged in the area of the base. The magnets of the drive device are each arranged on a first inner side of the first leg and on a second inner side of the second leg of the U-shaped base body. This advantageously allows for a space-saving, compact and resource-saving design.

Furthermore, a running rail is proposed for use with at least one transport device of a transport system. The running rail may comprise at least one curved running rail section, wherein the at least one transport device is guided along the at least one curved running rail section. The curved running rail section comprises at least a first running surface and a second running surface arranged on opposite sides of the curved running rail section. The first running surface and the second running surface each comprise a substantially rounded surface and each comprise a guide center. The guide center essentially forms a geometric center of a circle, the circular surface of which in each case approximately encloses the rounded surface of the first running surface or the rounded surface of the second running surface.

Advantageously, the geometry of the two running surfaces allows for a pivoting movement, preferably of the first and second rollers arranged on the movable element, along the rounded surface of the first running surface in a curved running rail section for readjusting the preload of the transport device and thus for maintaining the contact of said rollers. The roller profile may advantageously differ from the aforementioned running rail profile, which may e.g. approximately form a circular segment. As a result, the proposed running rail is advantageously compatible with many transport devices that have different roller profiles.

In a further embodiment, the running rail also comprises at least one straight running rail section which adjoins the curved running rail section. The curved running rail section comprises a first running surface spacing and the straight running rail section comprises a second running surface spacing. The first running surface spacing and the second running surface spacing are essentially identical.

Advantageously, the aforementioned distances between the running surfaces are essentially embodied identically, so that the distance between the running surfaces is, for example, approximately constant over the running rail-regardless of whether the running rail section is straight or curved. In order to ensure contact between the rollers and to readjust the preload, the first and second rollers are advantageously rotatably mounted on the above-mentioned movable element of the base body of the transport device in order to carry out the pivoting movement along the rounded surface of the first running surface in the curved area, i.e. in a curved running rail section.

The advantageous embodiments and further embodiments of the invention described above and/or reproduced in the subclaims may be used individually or in any combination with one another-except, for example, in cases of clear dependencies or incompatible alternatives.

It is to be noted that the figures are of a schematic nature only and are not drawn to scale. In this context, components and elements shown in the figures may be exaggerated in size or reduced in size for a better understanding. Furthermore, it is to be noted that the reference numerals in the figures have been chosen to remain unchanged if the elements and/or components and/or sizes are of the same embodiment.

The following figures describe an embodiment example of a transport system having at least one transport device. For example, the transport system may be a linear transport system that is used in automation technology. In addition to a linear drive, other drive systems are also conceivable for the transport system, such as a chain conveyor, a toothed belt drive or a drive system comprising a gearbox. The specification of the use of the transport system is not to be understood as restrictive, as the invention may be used in all transport systems in which at least one transport device is provided. The following figures are described with reference to a linear transport system, the at least one transport device of which is e.g. guided externally.

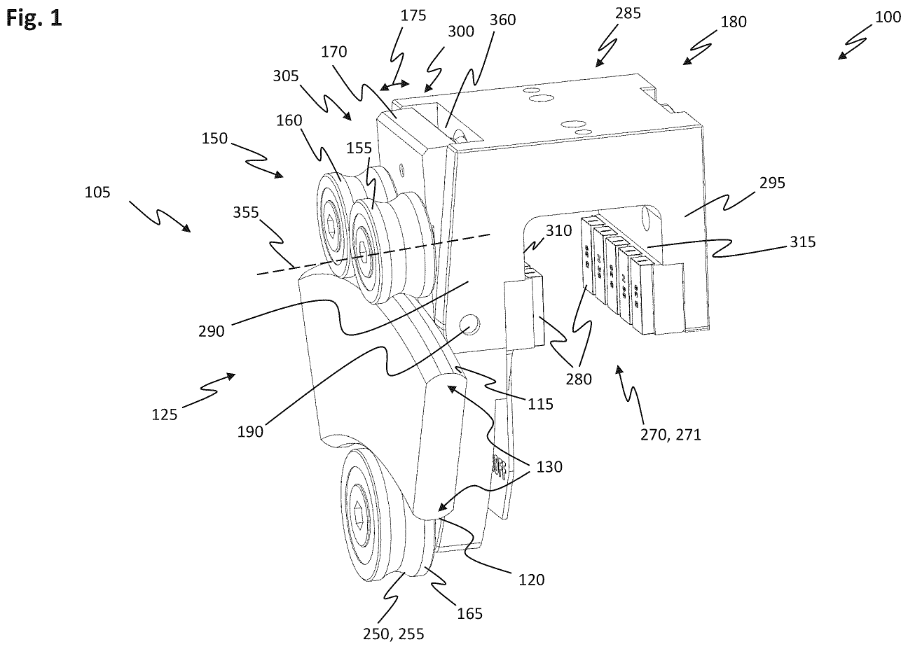

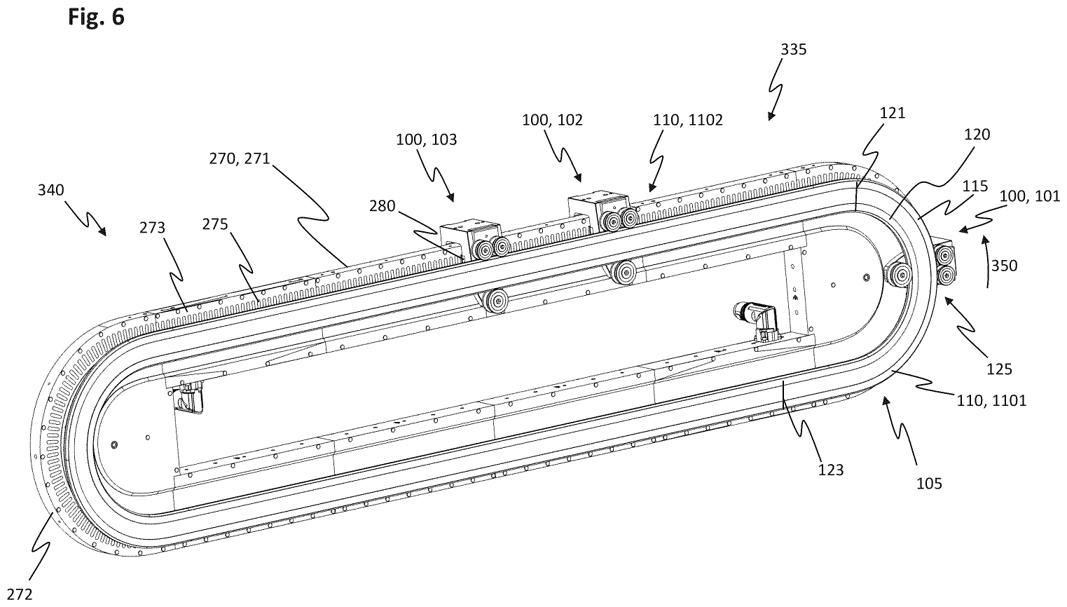

FIG. 1 shows a section of a transport system 335 having a transport device 100 and a running rail 105. The transport system 335 is consequently shown in FIG. 6, which is why FIGS. 1 and 6 are described in conjunction.

FIG. 6 eventually shows three transport devices, a first transport device 101, a second transport device 102 and a third transport device 103. The running rail 105 of the transport system 335 may, for example, form a steel rail. However, the material specification of the running rail 105 is only to be understood as an example and may also be implemented in a different manner. In FIG. 1, the running rail 105 has a curved embodiment. However, the running rail 105 may also have a straight embodiment. However, the running rail 105 may have any shape and may, for example, be composed of both straight running rail sections 1102 and curved running rail sections 1101.

In the embodiment shown in FIG. 6, the running rail 105 comprises at least one curved running rail section 1101 and at least one straight running rail section 1102, wherein the at least one straight running rail section 1102 adjoins the curved running rail section 1101 to form a closed running roller 340, for example a closed oval. However, the running rails 105 may also be embodied as an open system.

The curved running rail section 1101 comprises a first running surface spacing 121 and the straight running rail section 1102 comprises a second running surface spacing 123. Here, the first running surface spacing 121 and the second running surface spacing 123 each denote, for example, a distance between a first running surface 115 and a second running surface 120, which are arranged on opposite sides 125 of the curved running rail section 1101 and of the straight running rail section 1102. The first running surface spacing 121 may, for example, be identical to the second running surface spacing 123, i.e. have the same size or the same length. In other words, the running rail cross-section is, for example, constant for the curved running rail section 1101 and the straight running rail section 1102.

In FIG. 6, the first transport device 101 is guided in a guide direction 350 along the curved running rail section 1101. The second transport device 102 as well as the third transport device 103 are guided along the straight running rail section 1102.

In each case, the guiding may correspond to an outer guiding, since the first running surface 115 and the second running surface 120 are arranged on opposite sides 125 of the running rail 105. The guide direction 350 may be aligned or, respectively, oriented in the same way for the curved running rail section 1101 and the straight running rail section 1102, for example. It is to be understood that the number of transport devices 100 shown is merely exemplary and the transport system 335 is not limited thereto.

The first transport device 101, the second transport device 102 and the third transport device 103 may each comprise an identical structure and the same components, therefore the following descriptions (also in connection with the following figures) apply equally to the first transport device 101, second transport device 102 or third transport device 103. The transport devices 100 may also be referred to as a carriage, comprising a platform for transporting an object, as a trolley, comprising a holder for fastening and transporting an object, or as a mover. Moreover, further embodiments of the transport devices 100 are conceivable.

The transport device 100 comprises a plurality of rollers 150 which may e.g. be made of metal. Here too, however, the material specification is not to be understood as restrictive and may also be implemented in an alternative manner. For example, a first roller 155 and a second roller 160 are each rotatably in contact with the first running surface 115, while a third roller 165 is rotatably in contact with the second running surface 120, for example. Rotatable is to be understood here, for example, as meaning that the first roller 155 and the second roller 160 abut and roll on the first running surface 115 and the third roller 165 abuts and rolls on the second running surface 120. The rotatable contact or rolling may, for example, take place about a rotational roller axis 355, which runs approximately centrally through the rollers, but is only shown as an example for the first roller 155 in FIG. 1.

Alternatively, the transport device may also be embodied and constructed with a different number of rollers. In this case, at least one roller is provided at the transport device for each running surface. For example, the transport device 100 may be embodied with only the first roller 155, which rotatably abuts on the first running surface 115, and the third roller 165, which rotatably abuts on the second running surface 120. Any number of rollers may be provided at the transport device 100 for each running surface. The number of rollers per running surface may be different, as in the embodiment example shown in FIG. 1. Such an embodiment is particularly advantageous for curved running roller sections 1101 in order to allow for improved cornering. For example, all rollers may be implemented with the same roller diameter.

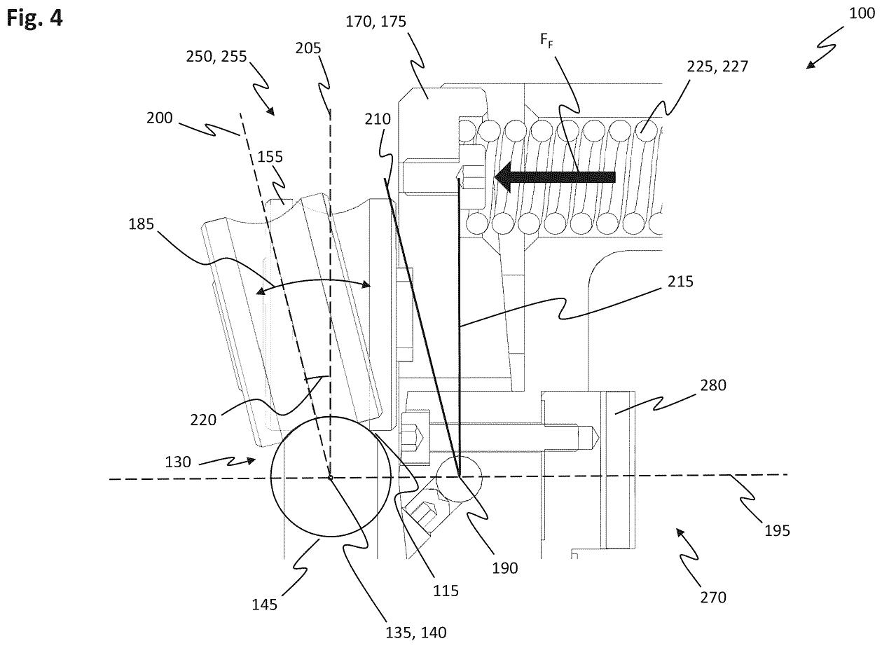

In FIG. 1, the first roller 155 and the second roller 160 are rotationally mounted 175, for example, on a movable element 170 of a base body 180 of the transport device 100. The rotational mounting 175, i.e. a rotatable or pivotable mounting, is indicated schematically with the aid of the arrow and is described in more detail in connection with FIG. 4. In addition or as an alternative, the third roller 165 may also be rotatably mounted 175 on a movable element 170 of the base body 180. In principle, at least the rollers associated with a running surface are rotatably mounted. This may also be a single roller.

The first roller 155 and the second roller 160, which are rotatably mounted 175 on the movable element 170, are each embodied to interact with the running rail 105, more precisely to interact with the formation of the first running surface 115. For this purpose, the first running surface 115 and the second running surface 120 each comprise a substantially rounded surface 130. This may be seen in more detail in FIG. 1, although the running rail 105 of the transport system 335 also comprises the rounded surface 130 on the second running surface 120. The interaction of the rotational mounting 175 of the first roller 155 and the second roller 160 with the substantially rounded surface 130 of the first running surface 115 is described in more detail with reference to the following figures.

The base body 180 of the transport device 100 is, for example, essentially U-shaped and comprises a base 285 with a first leg 290 and a second leg 295. In this case, the base body 180 may have a recess 360 at least partially on an outer side of the base 300 and an outer side of the first leg 305, in which the movable element 170 is arranged.

The transport system 335 further comprises a drive device 270 comprising a plurality of motor modules 271. The motor modules 271 may include arcuate motor modules 272 and straight motor modules 273, wherein the geometry of the motor modules 271 may be varied and combined as desired, as may be the contour of the curved running roller section 1101 and/or the straight running roller section 1102. The motor modules 271 are configured as linear motors and comprise a plurality of stator teeth 275. Electrical coils are wound around at least some of the stator teeth 275 and may be energized individually and separately from one another. In this way, it is possible to generate a magnetic field with the aid of the coils.

In addition, the drive device 270 comprises a plurality of magnets 280. The magnets 280 are, for example, in each case arranged on a first inner side 310 of the first leg 290 and a second inner side 315 of the second leg 295 of the base body 180 of the transport device 100. The magnets 280 arranged on the aforementioned surfaces of the base body 180 of the transport device 100 may be driven in conjunction with the magnetic field (traveling magnetic field) generated by the coils, without the need for further active drive elements on the transport device 100.

The current flow in the coils generates the magnetic field for an operative connection with the magnets 280 of the transport device 100. An operative connection describes an interaction of the magnetic field of the coils with the magnets 280 of the transport device 100, wherein the transport device 100 is moved along the curved running roller section 1101 or along the straight running roller section 1102.

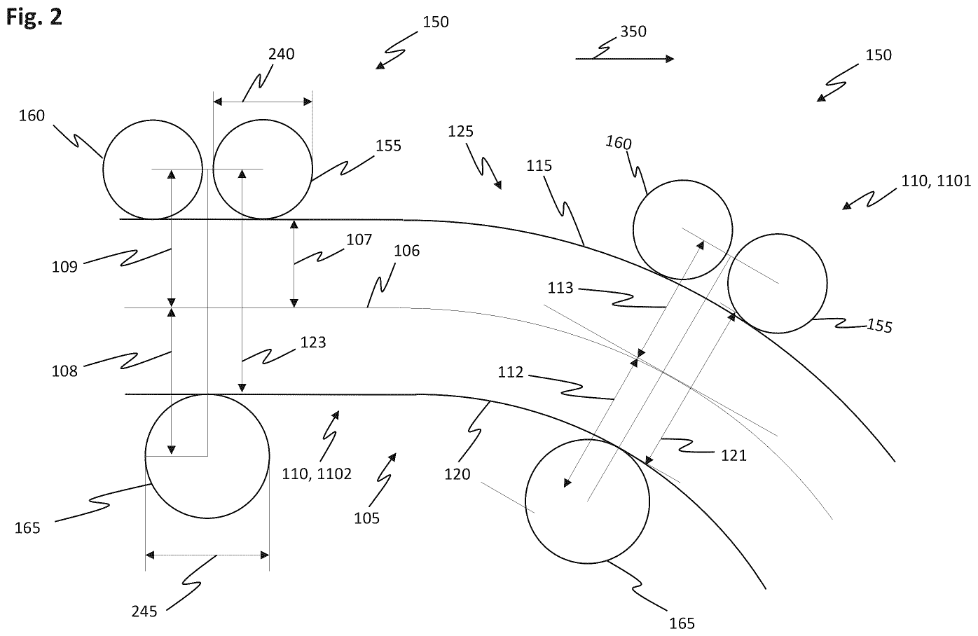

In order to maintain the operative connection and the associated thrust force for guiding the transport device 100, it is e.g. assumed that the magnets 280 of the transport device 100 should follow an approximately ideal path when guiding the transport device 100 along the running rail 105. The ideal path may, for example, lie in the center of the running rail 106, as shown in FIG. 2. A distance 107 to the center of the running rail 106 may be a first value A for the selected running rail 105, for the straight running rail section 1102 and for the curved running rail section 1101, respectively.

The above assumption is supported by the fact that a third distance 108 of the third roller 165 to the center of the running rail 106 for the straight running rail section 1102, for example, has a second value B, while a fifth distance 112 of the third roller 165 to the center of the running rail 106 for the curved running rail section 1101 also has the second value B. The third distance 108 and the fourth distance 109 of the third roller 165 to the center of the running rail 106 are thus constant in the area of the entire running rail 105. The single third roller 165 is thus able to maintain the distance 107 to the center of the running rail 106 and thus the ideal position of the path of the magnets 280. For this reason, the third roller 165 is rigidly fixed to the proposed transport device 100.

Two rollers of the transport device 100 arranged one behind the other in the guide direction 350, for example the first roller 155 and the second roller 160, are optimally arranged for straight travel (i.e. along the straight running rail section 1102) due to their geometry. However, when traveling in curves (i.e. along the curved running roller section 1101), the first roller 155 and the second roller 160 would want to leave the running roller due to their geometry, thereby creating an air gap or clearance. This is also known as the secant effect. For example, the first roller 155 would want to move out of the curve (i.e. the curved running rail section 1101) and lose contact with the first running surface 115 and the second roller 160 would want to move into the curve and not lose contact with the first running surface 115.

In order to prevent the aforementioned effect and to ensure that the first roller 155 and the second roller 160 also have contact with the first running surface 115 during cornering, the transport device 100 is embodied with the proposed rotationally mounted 175 movable element 170, which may be preloaded via a spring unit 222. The spring-loaded rotational mounting 175 of the first roller 155 and the second roller 160 with the aid of the movable element 170 allows for the position of the first roller 155 and the second roller 160 to be adjusted (and the preload of the transport device 100 in the curved running rail section 1101 to be readjusted).

The adjustment of the position of the first roller 155 and of the second roller 160 is carried out, for example, as shown in FIG. 2. The fourth distance 109 of the first roller 155 and the second roller 160 from the center of the running rail 106, at which the first roller 155 and the second roller 160 for the straight running rail section 1102 each have contact with the first running surface 115, has the second value B. A sixth distance 113 of the first roller 155 and the second roller 160 from the center of the running roller 105, wherein, that is, the first roller 155 and the second roller 160 for the curved running roller section 1101 each have contact with the first running surface 115, has a third value C for the selected running roller 105. Consequently, in order to maintain the contact of the two rollers, that is, the first roller 155 and the second roller 160, on the first running surface 115, a reduction of the fourth distance 109 of the first roller 155 and the second roller 160 from the center of the running rail 105 and the sixth distance 113 of the first roller 155 and the second roller 160 from the center of the running rail 105 of the two rollers, that is, the first roller 155 and the second roller 160, is required for the curved running rail section 1101.

The magnets 280 are generally arranged rather in the upper region of the transport device 100, as described in connection with the preceding figures; thus, in order to achieve an optimum operative connection or pushing force of the transport device 100 in accordance with the above assumption, the adjustment of the position of the plurality of rollers 150 may advantageously take place via the adjustment of the position of the first roller 155 and the second roller 160. In contrast, the push force may be reduced, for example, in the case of a rotational mounting 175 of the third roller 165, since the magnets 280 may then slip downwards from the ideal path over the center of the running rail 106 when the position of the third roller 165 is adjusted. As a result of the slipping, the magnets 280 would no longer sit at the optimum height for the operative connection with the coils (smaller overlap for generating the magnetic field) and would thus have a detrimental effect on the locomotion of the transport device 100.

The first roller 155, the second roller 160 and the third roller 165 in FIG. 2 are arranged in approximately a triangle shape, as is also shown in FIG. 1. The first roller 155 and the second roller 160 each comprise, for example, a first roller diameter 240, the first roller diameter 240 being shown, for example, by way of example in connection with the first roller 155 in FIG. 2. The third roller 165 comprises a second roller diameter 245. The first roller diameter 240 is, for example, smaller than the second roller diameter 245, since the third roller 165 is intended to bear the same load as the first roller 155 and the second roller 160 are both required to bear. In an embodiment with only two or even four rollers, the first roller diameter 240 and the second roller diameter 245 are of the same size in that case.

In order to ensure that the first roller 155, the second roller 160 and the third roller 165 always have sufficient contact with the first running surface 115 and the second running surface 120 of the curved running rail section 1101—as well as the straight running rail section 1102—a certain force is required to ensure that the first roller 155, the second roller 160 and the third roller 165 press against the first running surface 115 or the second running surface 120 of the running rail 105.

The force is also referred to as contact pressure, contact pressure or preload force or roller force. The terms are to be understood as synonyms. In principle, a high preload force is not required to establish contact between the rollers and the running surface. However, in order to ensure that the transport device sits as rigidly as possible on the running rail, an increased preloading force is used to ensure that the transport device does not tilt or only tilts slightly due to the dynamic forces or torques during travel or due to working forces. The more firmly the transport device is in contact with the running rail, the more dynamically or with more add-on mass the transport device may be operated.

Usually, the contact pressure of the transport device 100 on the straight rail section 1102 and the curved rail section 1101 differs. This means that the stability or rigidity of the transport device 100 on the rail 105 is not constant. Under certain circumstances, this may have a negative effect on the vibration behavior or control parameters to be set for the transport device 100 or the transport system 335. The aim is therefore to keep the contact pressure for the entire running rail 105, i.e. independent of the respective running rail section 110, approximately constant or to reduce the difference.

With the aid of the proposed transport device 100 with the proposed rotationally mounted 175 movable element 170, which may be preloaded via a spring unit 222, it is possible to reduce the difference in the contact pressure between the straight running rail section 1102 and the curved running rail section 1101 (the difference in the contact pressure for the straight running rail section 1102 and the contact pressure for the curved running rail section 1101 is generally around 10%). The specified magnitude is so small that it does not affect the control behavior of the transport device 100 or of the transport system 335. In other words, the transition between the straight rail section 1102 and the curved rail section 1101 no longer has a negative effect on the stability of the transport device 100 based on the proposed arrangement.

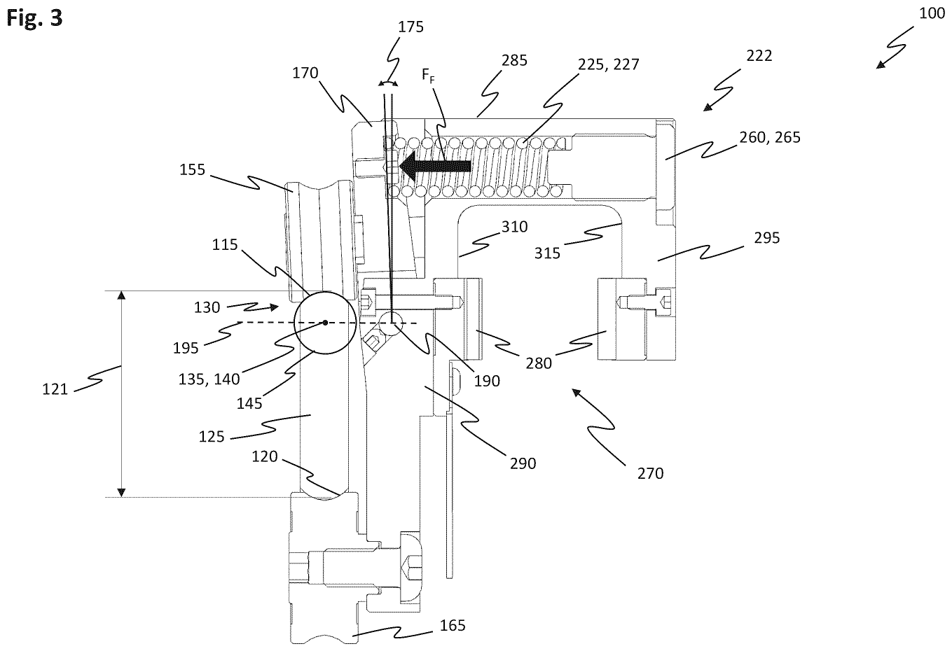

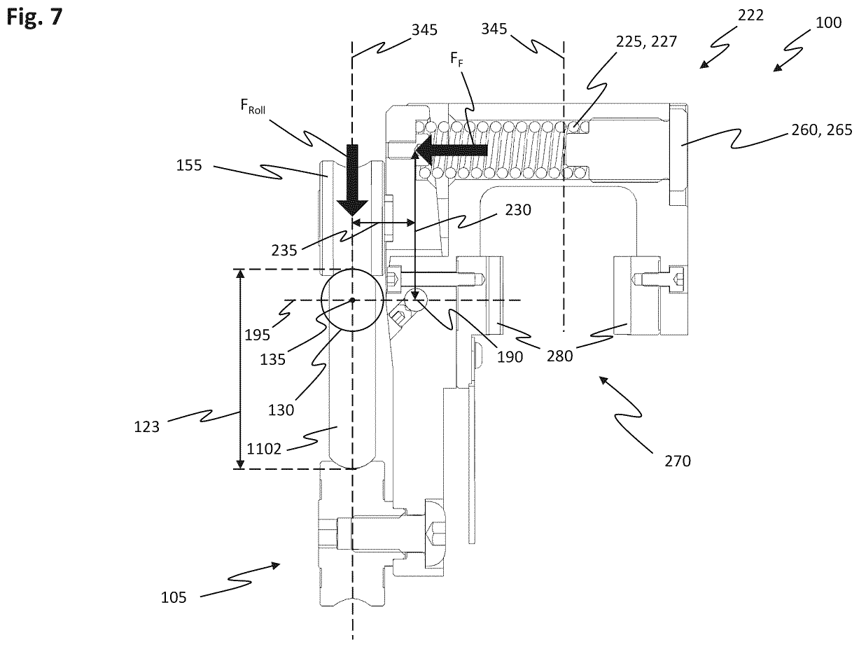

In the following, FIGS. 3 and 7 are described in conjunction, since they each show a sectional view of the first transport device 101 and of the second transport device 102, which is identical in construction and components, for better clarity of the individual components.

In contrast to FIG. 3, in which the first transport device 101 is guided along the curved running rail section 1101, for example, the first transport device 101 or the second transport device 102 in FIG. 7 is guided along the straight running rail section 1102.

FIG. 3 depicts the first running surface 115 and the second running surface 120 of the curved running rail section 1101, respectively. Each of these comprises the substantially rounded surface 130 and a guide center 135. The guide center 135 is to be understood as a geometric circle center 140, the circular surface 145 of which in each case approximately encloses the rounded surface 130 of the first running surface 115 or the rounded surface 130 of the second running surface 120. In the example shown, the guide center 135, i.e. the circle center 140 with the circular surface 145, is only shown for the first running surface 115. However, it should be understood that this was only done for reasons of clarity and does not represent a limitation.

In the embodiment example shown, the first roller 155 and the second roller 160 are rotatably mounted 175 on the movable element 170 of the base body 180. The rotatable or rotational mounting 175 is shown schematically with the aid of the arrow on both sides in FIG. 3. The movable element 170 may e.g. be embodied as a hinge block. It is also possible, as already explained, to use only one roller, for example the first roller 115, which is guided on the first running surface 115. Alternatively, further rollers may also be provided.

As already explained, the third roller 165 may also be rotatably mounted 175 on a movable element 170. Thus, the following descriptions apply equally to the third roller 165 on the second running surface 120 or also to other possible rollers on the second running surface 120.

The first roller 155 and the second roller 160 are embodied to carry out a pivoting movement 185 along the substantially rounded surface 130 of the first running surface 115 due to the rotational mounting 175, respectively, for the curved running rail section 1101 and for the transition from a straight running rail section 1102 to a curved running rail section 1101, to further maintain contact with the first roller 155 and the second roller 160 on the running rail 105 along a curved running rail section 1101 and during the transition from a straight running rail section 1102 to a curved running rail section 1101 on the first running surface 115 of the running rail 105 (as well as for readjusting the preload), as has been described above. The pivoting movement 185 is shown in more detail in FIG. 4.

A rotational axis 190 of the movable element 170, i.e. a rotational axis 190 of the movable element 170 embodied as a hinge block, for example, and the guide center 135 are arranged essentially at the same height 195 in FIGS. 3 and 7. The approximate arrangement at the same height 195 is indicated by the dashed line. Approximately at the same height 195 may also be understood as lying approximately in a joint plane. For example, the order of magnitude in the difference in the height arrangement of the rotational axis 190 and the guide center 135 may be up to about 1 mm.

The rotational or rotatable mounting 175 of the movable element 170 is thus realized via the rotational axis 190. The rotational axis 190 may, for example, be integrated into the base body 180 of the transport device 100. An advantage of the arrangement of the rotational axis 190 and the guide center 135 essentially at the same height 195 is that the stability of the transport device 100 on the running rail 105 continues to be ensured even during a pivoting movement 185 of the first roller 155 and the second roller 160 along the essentially rounded surface 130 of the first running surface 115 of the running rail 105. A pivoting movement 185 may also be a spring-in or spring-out process of the transport device 100.

The reason for this is that for the arrangement of the rotational axis 190 and the guide center 135 approximately at the same height 195, a possible torque of the transport device 100 is reduced during a pivoting movement 185 of the first roller 155 and the second roller 160. The torque is reduced and the transport device 100 does not tip over during said movement, but an approximately ideal parallel alignment 345 of the transport device 100 and the running rail 105 on the entire path 340 is given.

The transport device 100 is embodied, in particular with the aid of the above-mentioned arrangement of the rotational axis 190 and the guide center 135, to carry out the above-mentioned adjustment of the position of the first roller 155 and the second roller 160 for the transition from a straight running rail section 1102 to a curved running rail section 1101 advantageously with a repeat accuracy of millions of times.

The movable element 170, i.e. the hinge block, is preloaded via the spring unit 222, the spring unit 222 being adjacent to the movable element 170 in order to interact with the movable clement 170. For this purpose, the spring unit 222 comprises a spring element 225, which is preferably embodied as a helical compression spring 227, and a tensioning element 260, which is preferably embodied as a tensioning screw 265. The tensioning element 260, i.e. the tensioning screw 265, serves to preload the spring element 225 in order to provide a spring force F_{F} and to preload the transport device 100 on the running rail 105.

The spring force F_{F} is transmitted by the movable element 170, i.e. the hinge block, to the first roller 155 and the second roller 160, each in the form of a roller force F_{Roll}. The roller force F_{Roll} may, for example, denote the force that acts upon the first roller 155 and the second roller 160 upon contact with the first running surface 115 of the running rail 105. In this case, the roller force F_{Roll} is divided up equally between the first roller 155 and the second roller 160, while it acts individually on the third roller 165. The roller force F_{Roll} is only shown schematically for the first roller 155 in the illustration.

A particular advantage of using a helical compression spring 227 as a spring element 225 is the fact that it is hardly susceptible to wear or contributes to reducing the susceptibility to wear of the transport system 335 or of the transport device 100. A helical compression spring 227 has a high fatigue strength and may therefore be used optimally for adjusting the position of the first roller 155 and of the second roller 160 of the transport device 100 in response to curves and wear. The spring may be relatively soft, i.e. have a low stiffness. The low stiffness ensures that the spring force changes only slightly when the spring length is changed, for example during the transition from curved running rail 110 to straight running rail 111. This means that the transport device 110 remains constant on the running roller. Furthermore, a compact helical compression spring 227 may be used to advantageously save installation space in the design of the transport device 100 and of the transport system 335.

As an alternative to using a helical compression spring 227, a disk spring would also be conceivable, for example, which is very compact and may also generate a large spring force F_{F}. Further alternative spring elements or elastic elements with the above-mentioned properties are also conceivable.

In FIG. 7, the spring clement 225 and the rotational axis 190 are at a first distance 230 from each other. The first roller 155 and the second roller 160, which are each rotatably mounted 175 on the movable element 170, and the rotational axis 190 have a second distance 235. The first distance 230 is larger than the second distance 235.

Utilizing the lever law, this has the effect that the roller force F_{Roll} resulting from the spring force F_{F} is increased by the factor of first distance 230 divided by second distance 235 to press the rollers. The factor mentioned may, for example, have a value larger than 2.0. For example, the spring force F_{F} in the example mentioned may be approximately 100 N and the roller force F_{Roll} may then be 200 N, for example, due to the lever law, wherein the roller force F_{Roll} is divided up equally between the first roller 155 and the second roller 160 (F_{Roll}=200/2 N). The third roller 165, for example, may be subjected to the aforementioned roller force F_{Roll}=200 N. Utilizing the lever law for the arrangement shown, a relatively smaller spring element 225 in the form of a helical compression spring 227 may therefore be advantageously used. It is understood that the above numerical values are purely exemplary in nature and are not to be understood as limiting.

The above-mentioned contact pressure, pressure force, preloading force or roller force thus advantageously results from the spring force Fr. With the aid of the spring unit 222, both the first roller 155 and the second roller 160, which are fixed to the movable element 170, and the third roller 165 of the transport device 100, which is attached to the base body 180, are thus preloaded.

The above-mentioned magnets 280 of the drive device 270 are each arranged on a first inner side 310 of the first leg 290 and on a second inner side 315 of the second leg 295 of the U-shaped base body 180 of the transport device 100.

FIG. 4 shows an enlarged depiction of the transport device 100 in FIG. 3, in order to describe the process of the pivoting movement 185 in more detail for the first roller 155 as an example. The following explanation also applies to the second roller 160 and to the third roller 165, provided that this is also rotatably mounted 175 (in connection with the second running surface 120 of the running rail 105). The first roller 155 and the second roller 160 carry out the pivoting movement 185 along the substantially rounded surface 130 of the first running surface 115 of the running rail 105, during a transition from a straight running rail section 1102 to a curved running rail section 1101 (or from a curved running rail section 1101 to a straight running rail section 1102), or during guidance along the curved running rail section 1101, in order to maintain contact with the first running surface 115.

As described above, the position of the first roller 155 and the second roller 160 may be adjusted while carrying out the pivoting movement 185, i.e. the fourth distance 109 of the first roller 155 and the second roller 160 to the center 106 of the running rail 105 may be reduced to the sixth distance 113 of the first roller 155 and the second roller 160 to the center 106 of the running rail 105 (and the preload may be readjusted).

The spring force F_{F} provided by the spring unit 222 is transferred by the movable element 170 and its rotational axis 190 into the pivoting movement 185 of the first roller 155, i.e. into its rotational movement—similar to the principle of a pair of pliers—along the substantially rounded surface 130 of the first running surface 115 of the running rail 105. The pivoting movement 185 takes place, for example, away from the first leg 290 of the base body 180 of the transport device 100. In the example shown, the surface of the first running surface 115 is rounded. In the two-dimensional depiction, the first running surface 115 may, for example, form a segment of a circle. A profile 250 of the first roller 155 may, for example, correspond to a Gothic profile 255 in order to carry out an optimum pivoting movement 185 along the rounded surface 130. In addition, the first roller 155 may also have a rounded profile, a V-groove (prism) profile or an alternative profile that allows a pivoting movement 185 along the rounded surface 130 of the first running surface 115.

During the pivoting movement 185, the first roller 155 defines a pivoting plane 200, which is oriented 220 in an inclined manner with respect to a travel plane 205. For example, the pivoting plane 200 and the travel plane 205 may form an angle a with each other, with the angle forming an acute angle a, for example. The travel plane 205 may, for example, be oriented essentially parallel to a guide direction 350 of the first roller 155. The guide direction 350 may, for example, indicate the direction in which the first roller 155 is guided along the running rail 105, i.e. correspond to its rolling direction, for example. Within narrow limits, the pivoting movement 185 may therefore take place transversely to the rolling direction of the first roller 155. A first parallel displacement 210 of the pivoting plane 200 and a second parallel displacement 215 of the travel plane 205 are shown in FIG. 4 at the position of the rotational axis 190 of the movable element 170.

In the case of the fixed mounting of the third roller 165 and of the rotational mounting 175 of the first roller 155 and the second roller 160, the third roller 165 for the curved running roller section 1101 is oriented in parallel with regard to the travel plane 205, for example, while the first roller 155 and the second roller 160 for the curved running roller section 1101 are oriented in parallel with regard to the pivoting plane 200, for example.

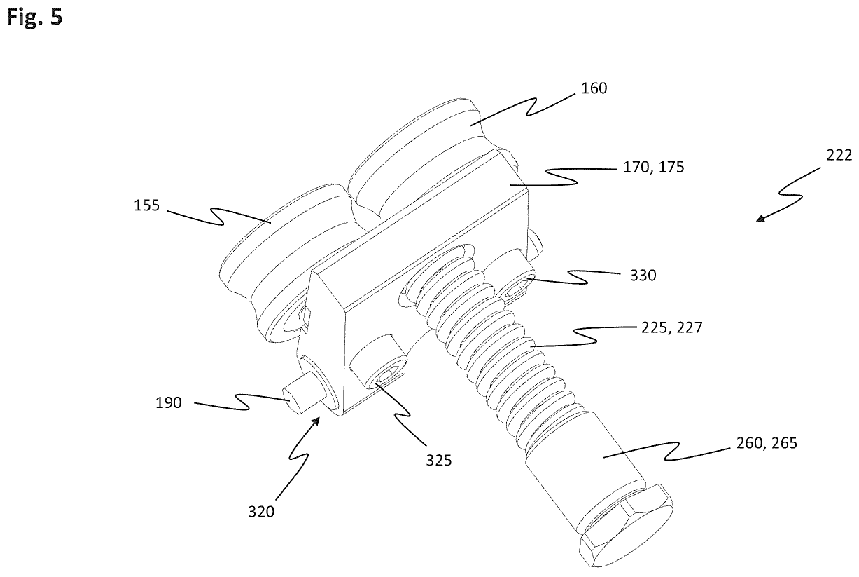

FIG. 5 shows an enlarged perspective view of the movable element 170 shown in FIGS. 3 and 4, at which the first roller 155 and the second roller 160 of the transport device 100 are rotatably mounted 175, together with the spring unit 222. The spring unit 222 comprises the tensioning clement 260 embodied as a tensioning screw 265 and the spring element 225 embodied as a helical compression spring 227.

In particular, the spring element 225 adjoins the movable element 170 embodied as a hinge block or opens into the movable element 170 embodied as a hinge block for the purpose of preloading. The first roller 155 is attached to the movable element 170 via a first fixing element 325. The second roller 160 is attached to the movable element 170 via a second fixing element 330. The first fixing element 325 and the second fixing element 330 may each be embodied as screws, for example. Alternatively, bolts or similar fixing elements would also be conceivable.

The movable element 170 comprises the rotational axis 190 arranged transversely with regard to the adjacent spring element 225. The rotational axis 190 may, for example, be in the form of a cylindrical pin. Since the movable element 170 carries out a pivoting movement 185 (i.e. a rotary movement) about the rotational axis 190 at each transition from a straight running rail section 1102 to a curved running rail section 1101 and at each transition from the curved running rail section 1101 to the straight running rail section 1102, the movable element 170 may be mounted 320. In order to extend the service life of the rotational axis 190, the mounting 320 of the movable element 170 may, for example, be provided with one or more plain bearings around the cylindrical pin as rotational axis 190.

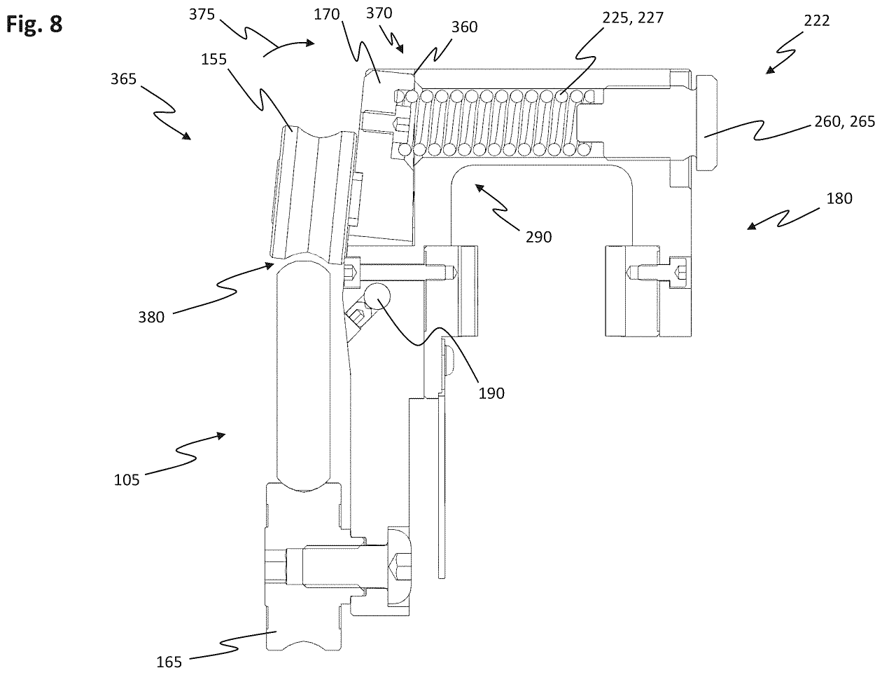

FIG. 8 shows a schematic depiction of a removal process 365 of the transport device 100 from the running rail 105. The proposed transport device 100 or the proposed transport system 335 allow a particularly simple removal of the transport device 100 from the running rail 105 (as well as a particularly simple placement of the transport device 100 on the running rail 105, the so-called rerailing), as will be described in the following. For the removal process 365, the tensioning clement 260 of the spring unit 222, i.e. the tensioning screw 265, must be loosened to such an extent that the spring element 225, i.e. the helical compression spring 227, is released.

If the spring element 225 relaxes, the spring force Fr no longer acts and the movable element 170, i.e. the hinge block, may be rotated in the direction 375 of the first leg 290 until the movable element 170 abuts 370 on the base body 180 in the recess 360. As a result of the rotation and the contact 370 of the movable element 170, the first roller 155 and the second roller 160 of the transport device 100 are lifted from the first running surface 115, so that a gap 380 is formed between the substantially curved surface 130 of the first running surface 115 and the first roller 155 and the second roller 160. The gap 380 is in particular an air gap.

The gap 380 is sufficiently large to first lift the first roller 155 and the second roller 160 from the first running surface 115 and then the third roller 165 from the second running surface 120, and thus to be able to remove the transport device 100 from the running rail 105. It will be understood that an insertion process (rerailing) of the transport device 100 onto the running rail 105 may be carried out in reverse order, for example starting with the placement of the fixed third roller 165 onto the second running surface 120.

Due to the positioning and construction of the spring unit 222 and due to the interaction with the movable element 170, it is thus possible to remove 365 the transport device 100 from the running rail 105 particularly easily or to place it on (running roller it on). This is because, as has been described above, no additional step is required for the removal process 365, such as the use of a rail lock, i.e. a special running rail section 110 tailored only for the removal or insertion process of the transport device 100, which generally requires a misalignment of at least one region of the running rail 105 for the use of the rail lock. Such a misalignment of the eavesdropping rail 105 may be advantageously prevented with the aid of the proposed transport device 100 and the proposed transport system 335.

The invention has been described in detail with the aid of preferred embodiments. Instead of the described embodiment examples, further embodiment examples are conceivable, which may have further variations or combinations of described features. For this reason, the invention is not limited by the disclosed examples, since other variations may be derived therefrom by the skilled person without departing from the scope of protection of the invention.

TABLE 1
List of reference symbols: 100-245

| | | | |
|---|---|---|---|
| 100 | transport device | 150 | plurality of rollers |
| 101 | first transport device | 151 | arrangement |
| 102 | second transport device | 155 | first roller |
| 103 | third transport device | 160 | second roller |
| 105 | running rail | 165 | third roller |
| 106 | center of running rail | 170 | movable element |
| 107 | distance to center of running rail | 175 | rotational mounting |
| 108 | third distance between third roller and | 180 | base body |
| | center of running roller | | |
| 109 | fourth distance of first roller and second | 185 | pivoting movement |
| | roller to center of running roller | | |
| 110 | running rail section | 190 | rotational axis |
| 1101 | curved running roller section | 195 | at substantially the same height |
| 1102 | straight running roller section | 200 | pivoting plane |
| 112 | fifth distance between third roller and | 205 | driving plane |
| | center of running roller | | |
| 113 | sixth distance of first roller and second | 210 | first parallel displacement pivoting plane |
| | roller to the center of running roller | | |
| 115 | first running surface | 215 | second parallel displacement driving |
| | | | plane |
| 120 | second running surface | 220 | inclined |
| 121 | first running surface spacing | 222 | spring unit |
| 123 | second running surface spacing | 225 | spring element |
| 125 | opposite sides | 227 | helical compression spring |
| 130 | essentially rounded surface | 230 | first distance |
| 135 | guide center | 235 | second distance |
| 140 | geometric circle center | 240 | first roller diameter |
| 145 | circular area | 245 | second roller diameter |

TABLE 2
List of reference symbols: 250-380

| | |
|---|---|
| 250 profile | 300 outer side of base |
| 255 Gothic profile | 305 outer side of first leg |
| 260 tensioning element | 310 first inner side of first leg |
| 265 tensioning screw | 315 second inner side of second leg |
| 270 drive unit | 320 mounting of movable element |
| 271 plurality of motor modules | 325 first fixing element |
| 272 arc-shaped motor module | 330 second fixing element |
| 273 straight motor module | 335 transport system |
| 275 stator teeth | 340 closed track |
| 280 magnets | 345 parallel alignment |
| 285 base | 350 guide direction |
| 290 first leg | 355 rotational roller axis |
| 295 second leg | 360 recess |
| F_{F} spring force | 365 removal process |
| F_{Roll} roller force | 370 abutting |
| A angle | 375 in direction towards the first leg |
| | 380 gap |

What is claimed is:

1. A transport system, comprising:
at least one running rail having at least one running rail section and at least one movable transport device, which is guided along the at least one running rail section;
wherein the running rail section comprises a first running surface,
wherein the first running surface comprises a substantially rounded surface and includes a guide center,
wherein the guide center substantially forms a geometric circle center, the circular surface of which approximately encloses the rounded surface of the first running surface,
wherein the transport device comprises at least a first roller which rotatably abuts on the first running surface,
wherein the first roller is rotatably mounted at least one movable element of a base body of the transport device in order to carry out a pivoting movement along the substantially rounded surface of the first running surface, and
wherein a rotational axis of the movable element and the guide center are arranged at substantially a same height for the pivoting movement.

2. The transport system according to claim 1, wherein:
the running rail comprises at least one curved running rail section comprising the first running surface and a second running surface disposed on opposite sides of the curved running rail section;
wherein the first running surface and the second running surface each comprise the substantially rounded surface and each comprise the guide center,
wherein the guide center in each case substantially forms the geometric circle center, the circular surface of which in each case approximately encloses the rounded surface of the first running surface or the rounded surface of the second running surface,
wherein the transport device comprises a plurality of rollers for guidance,
wherein at least the first roller and a second roller each rotatably abut on the first running surface and at least a third roller rotatably abuts on the second running surface,
wherein the first roller and the second roller and/or the third roller are rotatably mounted on at least one movable element of a base body of the transport device,
wherein the first roller and the second roller and/or the third roller, which are each rotatably mounted at the movable element, are each configured to carry out a pivoting movement along the substantially rounded surface of the first running surface and/or to carry out a pivoting movement along the substantially rounded surface of the second running surface, and
wherein a rotational axis of the movable element and the guide center are arranged at substantially the same height.

3. The transport system according to claim 1, wherein the first roller, during the pivoting movement, defines a respective pivoting plane which is oriented in an inclined manner with respect to a travel plane which is substantially in parallel with respect to a guide direction of the first roller.

4. The transport system according to claim 1, wherein the movable element for rotational mounting is preloaded via at least one spring unit which adjoins the movable element, wherein the spring unit comprises a spring element.

5. The transport system according to claim 4, wherein:
the spring element and the rotational axis are at a first distance from each other;
wherein the first roller, which is rotatably mounted on the movable element, and the rotational axis are at a second distance from each other, and
wherein the first distance is larger than the second distance.

6. The transport system according to claim 4, wherein:
the spring unit further comprises a tensioning element, which is configured as a tensioning screw; and
wherein the tensioning element is configured to preload the spring element, which is configured as a helical compression spring.

7. The transport system according to claim 1, further comprising:
a drive device for driving the transport device, which comprises motor modules having coils, which are configured along the running rail and individually energizable, and magnets arranged on the at least one transport device;
wherein the coils generate a magnetic field for an operative connection with the magnets arranged on the at least one transport device, and
wherein the at least one transport device is set in motion by the operative connection.

8. The transport system according to claim 7, wherein:
the base body of the transport device is substantially U-shaped and comprises a base having a first leg and a second leg;
wherein the base body comprises a recess at least partially on an outer side of the base and on an outer side of the first leg, the at least one movable element being arranged in the recess,
wherein the spring element is arranged in the region of the base, and
wherein the magnets of the drive device are each arranged on a first inner side of the first leg and on a second inner side of the second leg of the U-shaped base body.

9. A transport device for a transport system, wherein:
the transport system comprises at least one running rail having at least one running rail section;
wherein the transport device is guided along the at least one running rail section,
wherein the running rail section comprises a first running surface,
wherein the first running surface comprises a substantially rounded surface and comprises a guide center,
wherein the guide center substantially forms a geometric circle center, the circular surface of which approximately encloses the rounded surface of the first running surface,
wherein the transport device comprises at least a first roller which rotatably abuts on the first running surface,
wherein the first roller is rotatably mounted on at least one movable element of a base body of the transport device in order to carry out a pivoting movement along the substantially rounded surface of the first running surface, and
wherein a rotational axis of the movable element for the pivoting movement and the guide center are arranged at substantially a same height.

10. The transport device according to claim 9, wherein:
the running rail comprises at least one curved running rail portion having the first running surface and a second running surface arranged on opposite sides of the curved running rail portion;
wherein the first running surface and the second running surface each comprise the substantially rounded surface and each comprise the guide center,
wherein the guide center in each case substantially forms the geometric center of the circle, the circular surface of which in each case approximately encloses the rounded surface of the first running surface or the rounded surface of the second running surface,
wherein the transport device comprises a plurality of rollers for guiding,
wherein at least the first roller and a second roller each rotatably abut on the first running surface and at least a third roller rotatably abuts on the second running surface,
wherein the first roller and the second roller and/or the third roller are rotatably mounted on at least one movable element of a base body of the transport device,
wherein the first roller and the second roller and/or the third roller, which are each rotatably mounted on the movable element, are each configured to carry out a pivoting movement along the substantially rounded surface of the first running surface and/or to carry out a pivoting movement along the substantially rounded surface of the second running surface, and
wherein a rotational axis of the movable element and the guide center are arranged at substantially the same height.

11. The transport device according to claim 9, wherein the first roller, during the pivoting movement, in each case defines a pivoting plane which is oriented at an inclination relative to a travel plane which is substantially in parallel with respect to a guiding direction of the first roller.

12. The transport device according to claim 9, wherein the movable element for rotational mounting is preloaded via at least one spring unit adjoining the movable element, wherein the spring unit comprises a spring element.

13. The transport device according to claim 12, wherein:
the spring unit further comprises a tensioning element, which is configured as a tensioning screw; and
wherein the tensioning element is configured to preload the spring element, which is configured as a helical compression spring.

14. The transport device according to claim 12, wherein:
the base body of the transport device is substantially U-shaped and comprises a base having a first leg and a second leg;
wherein the base body comprises a recess at least partially on an outer side of the base and on an outer side of the first leg, the at least one movable element being arranged in said recess,
wherein the spring element is arranged in the region of the base, and
wherein magnets of a drive device for driving the transport device are each arranged on a first inner side of the first leg and on a second inner side of the second leg of the U-shaped base body;
wherein motor modules with coils of the drive device are configured along the running rail and individually energizable,
wherein the coils generate a magnetic field for an operative connection with the magnets arranged on the at least one transport device, and
wherein the at least one transport device is set in motion by the operative connection.

15. A running rail comprising:
at least one running rail section along which a transport device is guided;
wherein the running rail section comprises a first running surface,
wherein the first running surface comprises a substantially rounded surface and comprises a guide center,
wherein the guide center substantially forms a geometric circle center, the circular surface of which approximately encloses the rounded surface of the first running surface,
wherein the transport device comprises at least a first roller which rotatably abuts on the first running surface,
wherein the first roller is rotatably mounted on at least one movable element of a base body of the transport device in order to carry out a pivoting movement along the substantially rounded surface of the first running surface, and
wherein a rotational axis of the movable element for the pivoting movement and the guide center are arranged at substantially a same height.
